(19) United States
(12) Patent Application Publication
(10) Pub. No.: US 2024/0346684 A1
(43) Pub. Date: Oct. 17, 2024

(54) SYSTEMS AND METHODS FOR MULTI-PERSON POSE ESTIMATION

(71) Applicant: Shanghai United Imaging Intelligence Co., Ltd., Shanghai (CN)

(72) Inventors: Meng Zheng, Cambridge, MA (US); Jun Wang, Cambridge, MA (US); Benjamin Planche, Briarwood, NY (US); Zhongpai Gao, Rowley, MA (US); Ziyan Wu, Lexington, MA (US)

(73) Assignee: Shanghai United Imaging Intelligence Co., Ltd., Shanghai (CN)

(21) Appl. No.: 18/133,185

(22) Filed: Apr. 11, 2023

(51) Int. Cl. G06T 7/73

(52) U.S. Cl. CPC G06T 7/73; G06T 2207/20081; G06T 2207/30196

(57) ABSTRACT

Disclosed herein are systems, methods and instrumentalities associated with multi-person joint location and pose estimation based on an image that depicts multiple people in a scene, where at least some of the joint locations of a person may be blocked or obstructed by other people or objects in the scene. The estimation may be performed by detecting and grouping joint locations in the image using a bottom-up approach, and refining each group of detected joint locations by recovering obstructed joint location(s) that may be missing from the group. The detection, grouping, and/or refinement may be accomplished based on one or more machine learning (ML) models that may be implemented using artificial neural networks such as convolutional neural networks.

### BACKGROUND

Having the ability to accurately estimate the pose of a person based on a two-dimensional (2D) image of the person may be important for a variety of applications, including, e.g., medical applications in which patient positioning and/or surgical navigation may be automated based on a patient's pose. Pose estimation based a 2D images may be challenging due to lack of depth information and the task may become more complicated when multiple people may be present in the image and blocking each other (at least partially). In those situations, conventional pose estimation techniques may not be able to distinguish the multiple people or recover an obstructed joint, rendering the techniques ineffective for determining the pose and/or other physical characteristics of the people based on the image.

### SUMMARY

Disclosed herein are systems, methods and instrumentalities associated with multi-person joint location and/or pose estimation. According to embodiments of the present disclosure, an apparatus configured to perform a joint location and/or pose estimation task may include at least one processor configured to obtain an image that depicts at least a first person and a second person in a scene, and determine, based on a first machine learning (ML) model, a first group of joint locations and a second group of joint locations in the image that may belong to the first person and the second person, respectively. The processor may be further configured to refine at least one of the first group of joint locations or the second group of joint locations based on a second ML model, wherein one or more joint locations of the first person or the second person that may be missing from the first group of joint locations or the second group of joint locations may be recovered as a result of the refinement. Using the one or more recovered joint locations and at least one of the first group of joint locations or the second group of joint locations, the at least one processor may be further configured to perform a task associated with the first person or the second person, such as, e.g., determining a pose of the first person or the second person, constructing a 3D model for the first person or the second person, positioning the first person or the second person for a medical procedure, etc.

In examples, the one or more joint locations that may be missing from the first group of joint locations or second group of joint locations may include a joint location that may be obstructed, blocked, or otherwise undetectable in the image. In examples, the at least one processor may be configured to determine the first and second groups of joint locations by detecting a plurality of joint locations in the image, associate the plurality of joint locations with respective tag values (e.g., embedded values), and divide the plurality of joint locations into the first group of joint locations based on the tag values associated with the plurality of joint locations.

In examples, the first ML model may be trained to extract a first plurality of features from the image and detect the plurality of joint locations in the image based on the first plurality of features. In examples, a third ML model may be trained to extract a second plurality of features from the at least one of the first group of joint locations or the second group of joint locations, and the second ML model may be trained to fuse the first plurality of features and the second plurality of features, and recover the one or more joints missing from the first group of joint locations or the second group of joint locations based on the fused features. The fusing may be accomplished, for example, by averaging the first plurality of features and the second plurality of features, and the third ML model may be trained, for example, by providing a set of incomplete joint locations of a person to the third ML model, and forcing the third ML model to extract features from the set of incomplete joint locations and predict one or more missing joint locations of the person based on the extracted features.

In examples, the scene depicted by the image may be associated with a medical environment and the at least one processor may be configured to obtain the image from a sensing device (e.g., an image sensor) installed in the medical environment. In these examples, the first person or the second person may include a patient or a medical personnel.

### BRIEF DESCRIPTION OF THE DRAWINGS

A more detailed understanding of the examples disclosed herein may be had from the following description, given by way of example in conjunction with the accompanying drawings.

FIG. 1 is a simplified block diagram illustrating an example of multi-person body keypoint estimation in accordance with one or more embodiments of the present disclosure.

FIG. 2 is a simplified block diagram illustrating an example of body keypoint detection and refinement in accordance with one or more embodiments of the present disclosure.

FIG. 3 is another simplified block diagram illustrating an example of body keypoint detection and refinement in accordance with one or more embodiments of the present disclosure.

FIG. 4 is a flow diagram illustrating an example method for detecting and refining the body keypoints of multiple people in accordance with one or more embodiments of the present disclosure.

FIG. 5 is a flow diagram illustrating example operations that may be associated with training a neural network to perform one or more of the tasks described herein.

FIG. 6 is a simplified block diagram illustrating example components of an apparatus that may be used to perform one or more of the tasks described herein.

### DETAILED DESCRIPTION

The present disclosure is illustrated by way of example, and not by way of limitation, in the figures of the accompanying drawings. A detailed description of illustrative embodiments will be described with reference to these figures. Although the description may provide examples of possible implementations, it should be noted that the details are intended to be illustrative and in no way limit the scope of the application. It should also be noted that, while the examples may be described in the context of a medical environment, those skilled in the art will appreciate that the disclosed techniques may also be applied to other environments or use cases.

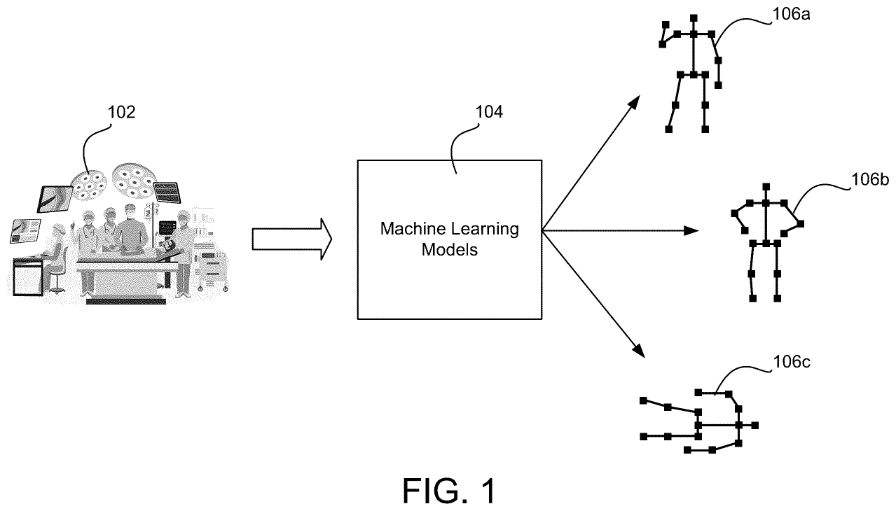

FIG. 1 is a diagram illustrating an example of using machine learning (ML) based technique to estimate the body keypoints (e.g., joint locations) and/or other physical characteristics of multiple people based on an image of those people. As shown, the image (e.g., 102 in FIG. 1) may be a two-dimensional (2D) image depicting the multiple people in an environment or scene such as a medical environment where a surgical and/or a scan procedure may be performed. In examples, image 102 may be captured using one or more sensing devices installed in the environment (e.g., cameras, depth sensors, thermal sensors, radar sensors, etc.), while the people captured in the image may include a patient and one or more medical professionals (e.g., surgeons, nurses, imaging technicians, etc.) providing care to the patient.

According to embodiments of the present disclosure, image 102 may be processed based on one or more ML models 104 trained (e.g., pre-trained) for detecting body keypoints (e.g., joints or joint locations) associated with the multiple people depicted in the image, grouping the detected body keypoints based on the individuals to whom those keypoints belong, refining the detected body keypoints (e.g., by predicting keypoints that may be obstructed in the image), and providing the refined body keypoints (e.g., 106a-106c) for the multiple people as an output of the ML model(s). The body keypoints obtained using ML model(s) 104 may include, for example, the joint locations (e.g., a complete set of joint locations) of one or more medical professionals (e.g., as indicated by 106a and 106b in FIG. 1) and/or the joint locations of a patient (e.g., as indicated by 106c in the FIG. 1), e.g., as the medical professionals and/or the patient are getting ready for or going through a medical procedure. The joint locations may be indicated, for example, by respective 2D coordinates (e.g., x-y coordinates) of the joint locations in an image space (e.g., associated with image 102) and may be used for a variety of purposes including, e.g., determining the respective poses of the people as depicted by image 102, registering image 102 with one or more medical scan images of the patient for 3D patient modeling, determining the position and/or gesture of the patient or the medical professionals, tracking of the actions of the medical professionals or the movements of the patient during a medical procedure, etc.

As will be described in greater detail below, the one or more ML models used to determine and/or refine the joint locations of the people in image 102 may be implemented through respective artificial neural networks (ANNs) that may be trained using images depicting people in various positions, poses, and/or environments, as well as a training dataset comprising joint location information of the people. To simulate the situation where one person's joints may be obstructed by another person or object in the same scene, certain joint locations of a person may be omitted (e.g., randomly) during the training of one or more of the ANNs and the ANN(s) may be forced to predict the omitted joint locations based on the available joint locations and/or anatomical relationships of the human joints that the one or more ANN(s) may learn through the training.

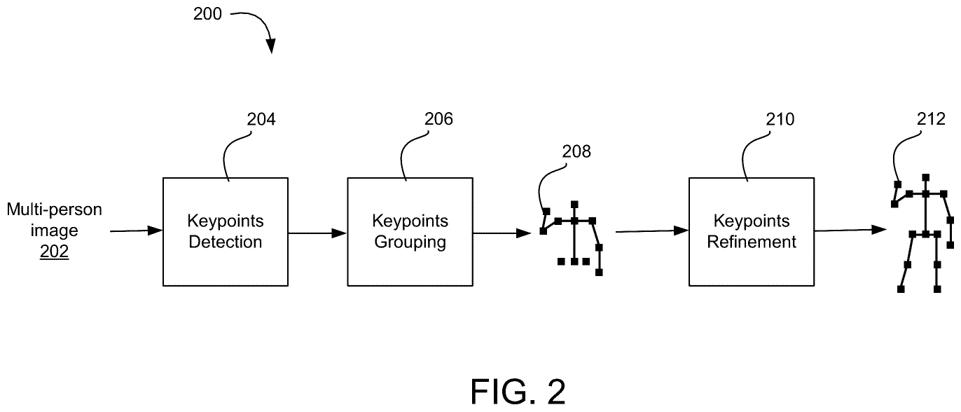

FIG. 2 illustrates an example process 200 that may be implemented by a computing apparatus for detecting the body keypoints (e.g., joint locations) of multiple people based on an input image 202 of the people and refining the detected body keypoints, for example, by recovering additional body keypoints that may be not visible in the image. As described herein, image 202 may be a 2D image (e.g., a 2D color image) depicting the people in a scene, wherein the people may be in different positions and poses, and wherein parts of a person's body may not be visible in the image due to obstruction or blockage by other people and/or objects in the scene. The process 200 for detecting and refining the body keypoints of the people may include detecting, at 204, multiple (e.g., all) keypoints that may be associated with the people depicted in image 202 by extracting features from the image (e.g., using an ANN such as a convolutional neural network) and identifying the keypoint locations of the people based on the extracted features (e.g., based on an ML model pre-trained for mapping respective sets of features to corresponding keypoints). Process 200 may further include dividing (e.g., classifying) the keypoints detected at 204 into different groups at 206, wherein each group of keypoints may belong to a respective person depicted in image 202 and may be connected to represent a full skeleton (e.g., if all of the keypoints of the person are correctly detected and classified at 204 and 206) or a partial skeleton of the person (e.g., if at least a subset of the keypoints of the person is not detected and correctly classified) at 208.

The operations at 204 and 206 may be performed in a bottom-up manner at least in the sense that the operations may involve detecting keypoints associated with all of the people in the image first (e.g., without distinguishing the keypoints based on personal identities) and then dividing the detected keypoints into groups each corresponding to a respective person of interest in the image. The division or grouping of the keypoints may be accomplished using various ML-based techniques, including, e.g., direct regression, affinity linking, associative embedding, etc. For instance, in examples where associative embedding is used for the grouping, an ML model (e.g., a neural network implementing the ML model) may be trained to produce a detection heatmap as well as a tagging heatmap for keypoints detected in the multi-person image 202, and then assemble the keypoints with similar tags into a same group that corresponds an individual detected in image 202. The detection heatmap may be generated, for example, by predicting a detection score at each pixel location for a keypoint (e.g., left wrist, right shoulder, etc.) regardless of the person to which the keypoint may belong. As such, the detection heatmap obtained using this technique may include multiple peaks representative of multiple left wrists belonging to different people, multiple right shoulders belonging to different people, etc. In addition to the keypoint detections, the ML model may also be trained to produce a tag (e.g., an embedding value) at each pixel location for each keypoint such that each joint heatmap may have a corresponding tag heatmap. So, if there are m keypoints to predict, then the ML model may output a total of 2m channels, m for detection and m for grouping. To parse the detections into individual groups, non-maximum suppression may be applied to obtain the peak detections for each keypoint and retrieve their corresponding tags (e.g., embedding values) at the same pixel location. The detections across body parts may then be grouped by comparing the tag values (e.g., embedding values) of the detections and matching up those that may be closely related (e.g., based on a pre-defined threshold), with each group of detections forming the pose estimate for an individual person.

To train the ML model described above, a detection loss and a grouping loss may be imposed on the output heatmaps. The detection loss may be determined, for example, based on the mean square error between each predicted detection heatmap and its ground truth heatmap. On the other hand, the grouping loss may assess how well the predicted tags agree with the ground truth grouping and the loss may be determined, for example, by retrieving the predicted tags for all body joints of all people at their ground truth locations and comparing the tags within each person and across people. Tags within a person should be the same, while tags across people should be different (e.g., the loss may be enforced to encourage similar tags for detections from the same group and different tags for detections across different groups).

Once an individualized group of keypoints is derived for a person of interest at 208, process 200 may further include refining the group of keypoints at 210 to recover one or more keypoints of the person that may be missing from the group, for example, due to obstruction and/or blockage, and obtain a refined group of keypoint 212 that may include the original group of keypoints 208 and the recovered keypoints. The refinement operation at 210 may be performed in a top-down manner since the operation may be localized to the group of keypoints 208 and performed as a single-person operation. Various machine-learning based techniques including a pre-trained ML model may be used to accomplish the refinement. The training of the ML model may be conducted using synthetically generated training data. For example, given a group of annotated keypoints (e.g., a complete or incomplete set of manually annotated human joints), multiple sets of training data each comprising a different number of keypoints may be synthetically generated (e.g., by omitting a random number of keypoints from the original group of annotated keypoints in each synthetically generated training dataset) and, during a training iteration, the ML model may be configured to receive one of the synthetically generated training datasets (e.g., with a certain number of missing keypoints) as an input, extract features from the input training dataset, and predict the original group of annotated keypoints based on the extracted features (e.g., which may contain information indicating the spatial relationship between the omitted keypoints and un-omitted keypoints). The parameters of the ML model may then be adjusted based on a difference or loss between the predicted keypoints and the original group of annotated keypoints.

One or more of the ML models described herein (e.g., for keypoint detection, grouping and/or refinement) may be implemented using respective artificial neural networks that may include a convolutional neural network (CNN) as a backbone. In examples, the CNN may include one or more convolutional layers (e.g., with associated linear or non-linear activation functions), one or more pooling layers, and/or one or more fully connected layers. Each of the aforementioned layers may include a plurality of filters (e.g., kernels) designed to detect (e.g., learn) features associated with a body keypoint. The filters may be associated with respective weights that, when applied to an input, produce an output indicating whether certain visual features have been detected. The weights associated with the filters may be learned by the neural network through a training process that may include inputting a large number of images from a training dataset to the neural network, predicting a result (e.g., features and/or body keypoint) using presently assigned parameters of the neural network, calculating a difference or loss (e.g., based on mean squared errors (MSE), L1/L2 norm, etc.) between the prediction and a corresponding ground truth, and updating the parameters (e.g., weights assigned to the filters) of the neural network so as to minimize the difference or loss (e.g., based on a stochastic gradient descent of the loss).

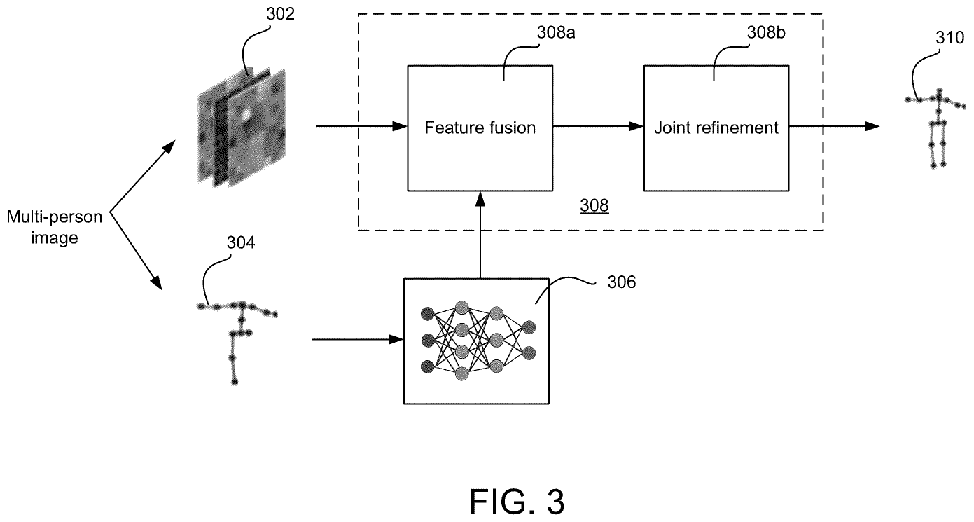

FIG. 3 illustrates example operations that may be associated with determining and refining body keypoints based on a multi-person input image in accordance with some embodiments of the present disclosure. As shown in FIG. 3, the operations may include obtaining, from the multi-person input image, one or more feature maps (or feature vectors) 302 and a preliminary set of body keypoints 304 that may be associated with a person depicted in the image. The feature maps 302 may be obtained using a pre-trained ML model as described herein, while the preliminary set of body keypoints 304 may be obtained through the keypoint detection (e.g., 204 of FIG. 2) and keypoint grouping (e.g., 206 of FIG. 2) operations described herein. Since the preliminary set of body keypoints 304 obtained through these operations may not include keypoints that are obstructed or otherwise undetectable in the multi-person input image, the preliminary set of body keypoints 304 may be subject to a refinement process to recover the missing keypoints. As shown in FIG. 3, the refinement process may be performed based on features extracted from the multi-person input image (e.g., as represented by feature maps 302) and features extracted from the preliminary set of body keypoints 304. In examples, the feature extraction from the preliminary set of body keypoints 304 may be performed using a neural network 306 that may be pre-trained for estimating body keypoints in the top-down manner described herein. For instance, during the training of neural network 306, the neural network may be configured to receive an incomplete set of body keypoints of a person, extract features from the incomplete body keypoints, and predict one or more body keypoints that may be missing from the incomplete set based on the extracted features. The keypoints predicted by the neural network may be added to the incomplete set to derive a refined (e.g., complete) set of keypoints for the person, which may then be used to evaluate and adjust the parameters of neural network 306, for example, based on a loss between the refined set of keypoints and a set of ground truth keypoints for the person (e.g., by backpropagating a gradient descent of the loss through the neural network).

Once trained, neural network 306 may be used to facilitate the training and/or operation (e.g., at an inference time) of another neural network 308 (e.g., another ML model) for refining the preliminary set of body keypoints 304 based on a combination of features extracted from the multi-person image 302 and the preliminary set of body keypoints 304. For example, during the training and/or inference operation of the neural network 308, neural network 306 may be used to extract features from the preliminary set of body keypoints 304 and provide the extracted features to neural network 308 (e.g., even though neural network 306 may be trained to make its own prediction about the keypoints missing from the preliminary set of body keypoints, only the features extracted by neural network 306 may be used by neural network 308 during its training and inference operation). In addition to the features extracted by neural network 306 from the preliminary set of body keypoints 304, neural network 308 may also obtain features 302 from the multi-person input image and may fuse (e.g., combine) the two sets of features at 308a, for example, by taking an average of the two sets of features (e.g., by averaging the feature maps or feature vectors representing the two sets of features). Based on the fused features, neural network 308 may predict the keypoints missing from the preliminary set of body keypoints 304 and may generate a refined (e.g., more complete) keypoint set 310 by adding the predicted keypoints to the preliminary set of body keypoints 304. During the training of neural network 308, the refined keypoint set 310 may be compared to corresponding ground truth keypoints to determine a loss associated with the prediction, which may then be used to update the parameters of neural network 308, for example by backpropagating a gradient descent of the loss through the neural network. During an inference operation of neural network 308, the refined keypoint set 310 may be used to perform one or more downstream tasks, including, e.g., estimating a pose of the person to whom the keypoints may belong and using the pose for patient positioning, patient motion estimation, and/or the like.

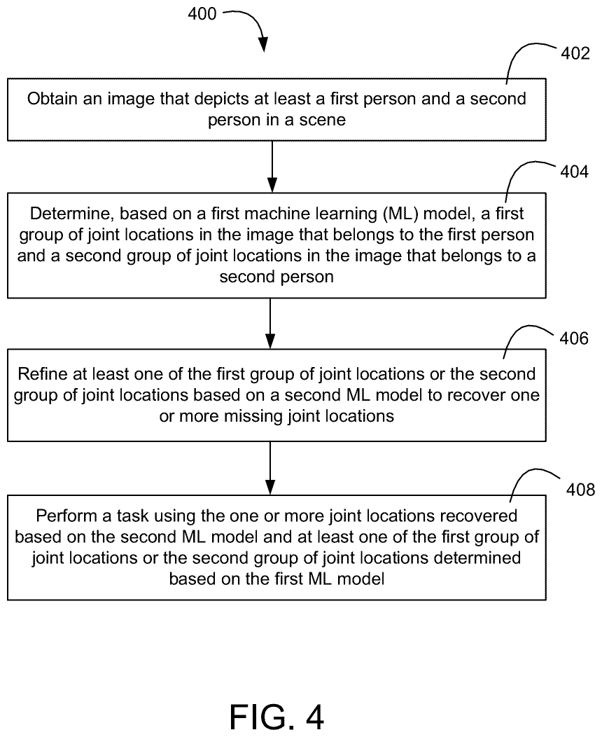

FIG. 4 is a flow diagram illustrating an example method 400 for detecting and refining the body keypoints of multiple people based on an image depicting the multiple people in a scene (e.g., in a medical environment). As shown in FIG. 4, method 400 may include obtaining the image that depicts the multiple people (e.g., at least a first person and a second person) at 402, and determining, based on a first machine learning (ML) model, a first group of joint locations in the image that may belong to the first person and a second group of joint locations in the image that belongs to the second person at 404. As described herein, the first and second groups of joint locations may be determined using a bottom-up detection technique that may involve detecting multiple joint locations in the image without personal identities and then classifying the detected joint locations into groups that may correspond to the first person and the second person, respectively.

Process 400 may also include refining at least one of the first group of joint locations or the second group of joint locations at 406 based on a second ML model, wherein the refinement may recover one or more joint locations of the first person or the second person that may be missing from the first group of joint locations or second group of joint locations due to blockage, obstruction or other reasons. The refined group of joint locations for the first person or the second person including the originally detected joint locations and the recovered joint locations may then be used at 408 to perform one or more downstream tasks, such as, e.g., determining the pose of the first person or the second person, constructing a 3D human model for the first person or the second person, positioning the first person or the second person for a medical procedure, etc.

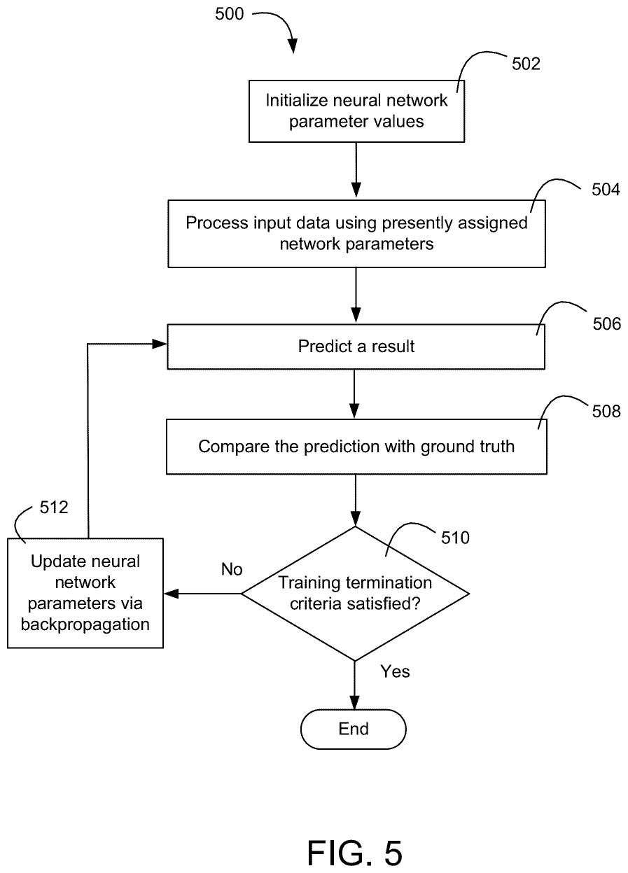

FIG. 5 illustrates example operations that may be associated with training a neural network (e.g., an ML model implemented by the neural network) for performing one or more of the tasks described herein. As shown, the training operations may include initializing the operating parameters of the neural network (e.g., weights associated with various layers of the neural network) at 502, for example, by sampling from a probability distribution or by copying the parameters of another neural network having a similar structure. The training operations may further include processing an input (e.g., a training image) using presently assigned parameters of the neural network at 504, and making a prediction for a desired result (e.g., a feature vector, pose and/or shape parameters, a human model, etc.) at 506. The prediction result may then be compared to a ground truth at 508 to determine a loss associated with the prediction based on a loss function such as mean squared errors between the prediction result and the ground truth, an L1 norm, an L2 norm, etc. The loss may be used to determine, at 510, whether one or more training termination criteria are satisfied. For example, the training termination criteria may be determined to be satisfied if the loss is below a threshold value or if the change in the loss between two training iterations falls below a threshold value. If the determination at 510 is that the termination criteria are satisfied, the training may end; otherwise, the presently assigned network parameters may be adjusted at 512, for example, by backpropagating a gradient descent of the loss function through the network before the training returns to 506.

For simplicity of explanation, the operations of the methods are depicted and described herein with a specific order. It should be appreciated, however, that these operations may occur in various orders, concurrently, and/or with other operations not presented or described herein. Furthermore, it should be noted that not all operations that the apparatus is capable of performing are depicted in the drawings or described herein. It should also be noted that not all illustrated operations may be required to be performed.

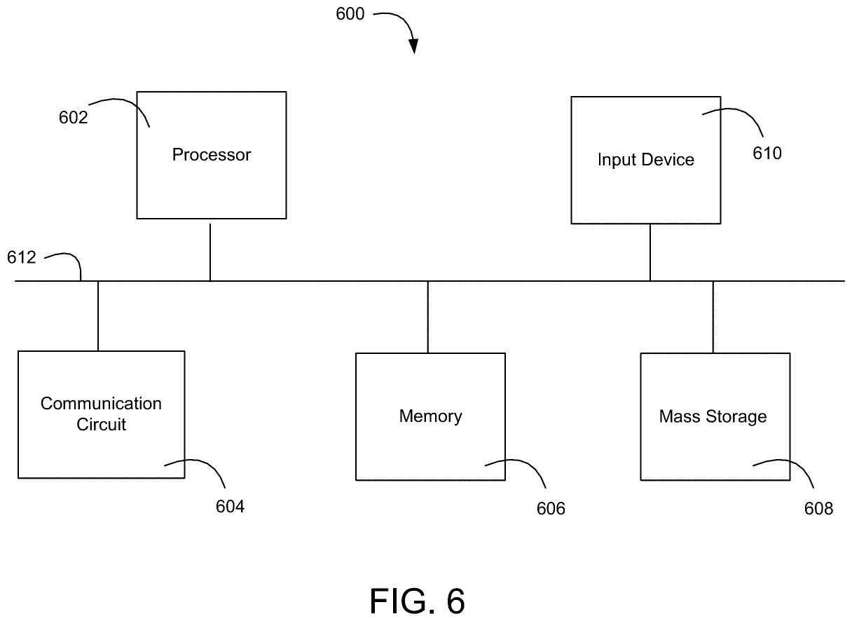

The systems, methods, and/or instrumentalities described herein may be implemented using one or more processors, one or more storage devices, and/or other suitable accessory devices such as display devices, communication devices, input/output devices, etc. FIG. 6 is a block diagram illustrating an example apparatus 600 that may be configured to perform the tasks described herein. As shown, apparatus 600 may include a processor (e.g., one or more processors) 602, which may be a central processing unit (CPU), a graphics processing unit (GPU), a microcontroller, a reduced instruction set computer (RISC) processor, application specific integrated circuits (ASICs), an application-specific instruction-set processor (ASIP), a physics processing unit (PPU), a digital signal processor (DSP), a field programmable gate array (FPGA), or any other circuit or processor capable of executing the functions described herein. Apparatus 600 may further include a communication circuit 604, a memory 606, a mass storage device 608, an input device 610, and/or a communication link 612 (e.g., a communication bus) over which the one or more components shown in the figure may exchange information.

Communication circuit 604 may be configured to transmit and receive information utilizing one or more communication protocols (e.g., TCP/IP) and one or more communication networks including a local area network (LAN), a wide area network (WAN), the Internet, a wireless data network (e.g., a Wi-Fi, 3G, 4G/LTE, or 5G network). Memory 606 may include a storage medium (e.g., a non-transitory storage medium) configured to store machine-readable instructions that, when executed, cause processor 602 to perform one or more of the functions described herein. Examples of the machine-readable medium may include volatile or non-volatile memory including but not limited to semiconductor memory (e.g., electrically programmable read-only memory (EPROM), electrically erasable programmable read-only memory (EEPROM)), flash memory, and/or the like. Mass storage device 608 may include one or more magnetic disks such as one or more internal hard disks, one or more removable disks, one or more magneto-optical disks, one or more CD-ROM or DVD-ROM disks, etc., on which instructions and/or data may be stored to facilitate the operation of processor 602. Input device 610 may include a keyboard, a mouse, a voice-controlled input device, a touch sensitive input device (e.g., a touch screen), and/or the like for receiving user inputs to apparatus 600.

It should be noted that apparatus 600 may operate as a standalone device or may be connected (e.g., networked, or clustered) with other computation devices to perform the functions described herein. And even though only one instance of each component is shown in FIG. 6, a skilled person in the art will understand that apparatus 600 may include multiple instances of one or more of the components shown in the figure.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description.

What is claimed is:

1. An apparatus, comprising:
at least one processor configured to:
obtain an image that depicts at least a first person and a second person in a scene;
determine, based on a first machine learning (ML) model, a first group of joint locations in the image that belongs to the first person and a second group of joint locations in the image that belongs to a second person;
refine at least one of the first group of joint locations or the second group of joint locations based on a second ML model, wherein one or more joint locations of the first person or the second person that are missing from the corresponding first group of joint locations or second group of joint locations are recovered based on the second ML model; and
perform a task using the one or more joint locations recovered based on the second ML model and at least one of the first group of joint locations or the second group of joint locations determined based on the first ML model.

2. The apparatus of claim 1, wherein the one or more joint locations that are missing from the first group of joint locations or second group of joint locations includes a joint location that is obstructed in the image.

3. The apparatus of claim 1, wherein the at least one processor being configured to determine the first group of joint locations and the second group of joint locations in the image comprises the at least one processor being configured to detect a plurality of joint locations in the image, associate the plurality of joint locations with respective tag values, and divide the plurality of joint locations into the first group of joint locations that belongs to the first person and the second group of joint locations that belongs to the second person based on the tag values associated with the plurality of joint locations.

4. The apparatus of claim 3, wherein the first ML model is trained at least to extract a first plurality of features from the image and detect the plurality of joint locations in the image based on the first plurality of features.

5. The apparatus of claim 4, wherein the at least one processor is further configured to extract a second plurality of features from the at least one of the first group of joint locations or the second group of joint locations, and to recover the one or more joints missing from the first group of joint locations or the second group of joint locations based on the first plurality of features and the second plurality of features.

6. The apparatus of claim 5, wherein the at least one processor is configured to extract the second plurality of features based on a third ML model trained for receiving a set of incomplete joint locations of a person, extracting features from the set of incomplete joint locations, and predicting one or more joint locations of the person that are missing from the set of incomplete joint locations based on the extracted features.

7. The apparatus of claim 5, wherein the second ML model is trained at least to fuse the first plurality of features and the second plurality of features, and to determine the one or more joint locations missing from the first group of joint locations or the second group of joint locations based on the fused features.

8. The apparatus of claim 7, wherein the second ML model is trained to fuse the first plurality of features and the second plurality of features by averaging the first plurality of features and the second plurality of features.

9. The apparatus of claim 1, wherein the scene depicted by the image is associated with a medical environment and wherein the at least one processor is configured to obtain the image from a sensing device installed in the medical environment.

10. The apparatus of claim 1, wherein the task performed by the at least one processor includes determination of a pose of the first person or the second person.

11. A method of image processing, the method comprising:
obtaining an image that depicts at least a first person and a second person in a scene;
determining, based on a first machine learning (ML) model, a first group of joint locations in the image that belongs to the first person and a second group of joint locations in the image that belongs to a second person;
refining at least one of the first group of joint locations or the second group of joint locations based on a second ML model, wherein one or more joint locations of the first person or the second person that are missing from the corresponding first group of joint locations or second group of joint locations are recovered based on the second ML model; and
performing a task using the one or more joint locations recovered based on the second ML model and at least one of the first group of joint locations or the second group of joint locations determined based on the first ML model.

12. The method of claim 11, wherein the one or more joint locations that are missing from the first group of joint locations or second group of joint locations includes a joint location that is obstructed in the image.

13. The method of claim 11, wherein determining the first group of joint locations and the second group of joint locations in the image comprises detecting a plurality of joint locations in the image, associating the plurality of joint locations with respective tag values, and dividing the plurality of joint locations into the first group of joint locations that belongs to the first person and the second group of joint locations that belongs to the second person based on the tag values associated with the plurality of joint locations.

14. The method of claim 13, wherein the first ML model is trained at least to extract a first plurality of features from the image and detect the plurality of joint locations in the image based on the first plurality of features.

15. The method of claim 14, further comprising extracting a second plurality of features from the at least one of the first group of joint locations or the second group of joint locations, wherein the one or more joints missing from the first group of joint locations or the second group of joint locations are recovered based on the first plurality of features and the second plurality of features.

16. The method of claim 15, wherein the second plurality of features is extracted based on a third ML model trained for receiving a set of incomplete joint locations of a person, extracting features from the set of incomplete joint locations, and predicting one or more joint locations of the person that are missing from the set of incomplete joint locations based on the extracted features.

17. The method of claim 15, wherein the second ML model is trained at least to fuse the first plurality of features and the second plurality of features, and to determine the one or more joint locations missing from the first group of joint locations or the second group of joint locations based on the fused features.

18. The method of claim 17, wherein the second ML model is trained to fuse the first plurality of features and the second plurality of features by averaging the first plurality of features and the second plurality of features.

19. The method of claim 1, wherein the task performed by the at least one processor includes determination of a pose of the first person or the second person.

20. A non-transitory computer-readable medium comprising instructions that, when executed by a processor included in a computing device, cause the processor to implement the method of claim 11.
